(19) United States
(12) Patent Application Publication
(10) Pub. No.: US 2008/0295232 A1
(43) Pub. Date: Dec. 4, 2008

(54) SYSTEMS AND METHODS FOR DYEING INHERENTLY FLAME RESISTANT FIBERS WITHOUT USING ACCELERANTS OR CARRIERS

(75) Inventors: Rembert Joseph Truesdale, III, Thomaston, GA (US); Phillip Howell Riggins, Greensboro, NC (US)

Correspondence Address: JOHN S. PRATT, ESQ;KILPATRICK STOCKTON, LLP, 1100 PEACHTREE STREET, ATLANTA, GA, 30309, US

(73) Assignee: Southern Mills, Inc., Union City, GA (US)

(21) Appl. No.: 12/117,333

(22) Filed: May 8, 2008

Related U.S. Application Data
(60) Provisional application No. 60/928,204, filed on May 8, 2007.

(51) Int. Cl. A62B 17/00; D06P 5/00; D06P 3/24; A41D 1/00; D06P 3/52

(52) U.S. Cl. 2/458; 8/531; 8/529; 8/532; 2/81; 2/69

(57) ABSTRACT

Systems and methods for dyeing inherently flame resistant fibers, and particularly aramid fibers, without the use of accelerants or carriers. Fabrics made from aramid fibers or blends thereof are immersed in an aqueous dye bath that includes at least one dye and at least one acid component. The temperature of the dye bath is increased from room temperature to a suitable temperature (e.g., between approximately 285° F. to 400° F.) capable of rendering the aramid fibers less crystalline so that the fibers can accept the dye. In this way, suitable color yields may be obtained without the use of accelerants or carriers as have been required in the past.

### CROSS REFERENCE TO RELATED APPLICATIONS

This application claims the benefit of U.S. Provisional Application No. 60/928,204, filed May 8, 2007.

### FIELD OF THE INVENTION

The present invention relates to systems and methods for dyeing inherently flame resistant fibers and particularly aramid fibers without the use of accelerants or carriers.

### BACKGROUND OF THE INVENTION

Inherently flame resistant (“FR”) fibers, such as aramid fibers, are often used in FR fabrics and garments designed to protect the wearer against heat and flame. Such protective fabrics and garments are offered in a variety of colors, thus requiring that the inherently flame resistant fibers in such fabrics be dyed.

Historically, dyeing of aramid fibers has required use of accelerants or dye assists, also called “carriers,” in the dyeing process. Examples of conventional carriers include organic solvents such as acetophenone, aromatic alcohols or amides, and aryl ethers.

When carriers such as these organic solvents are used to color aramid fibers, the carriers are imbibed into the fibers, and may not be easily removed. Retention of these organic solvents in the fibers can lead to fabric flammability or color fastness problems such as bleeding, staining during laundering, or poor colorfastness to light. If amounts of organic solvents are retained in the fibers and the fibers are used in fabrics, a distinctive, unpleasant odor may be present in the fabrics thereby making them undesirable for consumers to wear. Accordingly, it is desirable to provide a system and method for dyeing inherently flame resistant fibers, and particularly aramid fibers, that does not require use of accelerants or carriers.

### SUMMARY OF THE INVENTION

This invention relates to systems and methods for dyeing inherently flame resistant fibers, and particularly aramid fibers, without the use of accelerants or carriers. In one embodiment, fabrics made from aramid fibers or blends thereof are immersed in an aqueous dye bath that includes at least one dye and at least one acid component. The temperature of the dye bath is increased from room temperature to a suitable temperature (e.g., between approximately 285° F. to 400° F.) capable of rendering the aramid fibers less crystalline so that the fibers can accept the dye. In this way, suitable color yields may be obtained without the use of accelerants or carriers as have been required in the past. Fabrics dyed in accordance with the invention may subsequently be used to make a variety of protective garments, including, but not limited to, coveralls, jumpsuits, shirts, jackets, vests, and trousers, for protecting the wearer against thermal hazards such as electrical arcs and flames.

### DETAILED DESCRIPTION OF THE INVENTION

Embodiments of this invention relate to a process by which inherently flame resistant fibers, and particularly aramid fibers, are dyed either when in the fiber stage or after incorporation into a fabric. Examples of aramid fibers suitable for dyeing in accordance with the methods disclosed herein include para-aramid fibers, meta-aramid fibers, and blends thereof. Examples of para-aramid fibers include, but are not limited to, KEVLAR™ (such as 970, available from DuPont) and TWARON™ (available from Teijin Twaron BV of Arnheim, Netherlands). Examples of meta-aramid fibers include, but are not limited to, NOMEX™ (such as staple NOMEX™ fibers marketed as T462, T455, T450, and N303 and filament NOMEX™ fibers marketed as T430, all available from DuPont), CONEX™ (available from Teijin), APYEIL™ (available from Unitika), and TANLON™ (available from Shanghai Tanlon Fiber Company). Examples of aramid blends include, but are not limited to, 88 CONEX™/10 TWARON™ (with 2% antistat fiber) and Caldura S/239 (a fabric containing both NOMEX™ fibers T450 and T430). While specific embodiments of this invention are described for use in dyeing aramid fibers or blends thereof, it is also contemplated that other types of inherently FR fibers, including for example polybenzimidazole (PBI), melamine, polyamide, polyimide, and polyimideamide may also be dyed in accordance with the methods disclosed herein. In one embodiment, an exhaust dyeing process is used to dye the aramid fibers. For purposes of discussion, the dyeing process is discussed for use on a fabric that is made from undyed aramid fibers. However, one of skill in the art will readily understand that the aramid fibers may be first dyed in accordance with the disclosed methods and subsequently incorporated into a yarn or fabric or alternatively may be first incorporated into a yarn or a fabric and then dyed. Thus, the following process is suitable for dyeing the aramid fibers at the fiber stage, the yarn stage, or the fabric stage.

In this process, the fabric is immersed in an aqueous dye bath that includes at least one dye and at least one acid component. Suitable dyes include basic dyes, disperse dyes, and acid dyes, examples (but certainly not exhaustive lists) of each of which (both suitable and potentially unsuitable) are provided in Table 1 below.

Suitable acid components can include, but are not limited to, non-volatile acids or acid salts such as citric acid, oxalic acid, adipic acid, and urea sulfate as well as volatile organic acids such as acetic or formic acids. Citric acid and urea sulfate have proven particularly effective in the disclosed dyeing methods.

After immersing the fabric in the dye bath, the bath (and thus the aramid fibers) is heated. The temperature of the dye bath can be increased from room temperature to a suitable temperature capable of rendering the aramid fibers less crystalline so that the fibers can accept the dye. Temperatures in the range of approximately 285 degrees Fahrenheit (140.5 degrees Celsius) to approximately 400 degrees Fahrenheit (205 degrees Celsius) have proven adequate to promote dyeing of the aramid fibers. Upon reaching the predetermined peak temperature, the dye bath is maintained at a desired range of temperatures for about 20 to 120 minutes to allow dye to penetrate the fibers. After expiration of a desired period, the dye bath is cooled until the fabric is at a temperature at which it can be handled, such as approximately 113 degrees Fahrenheit (45 degrees Celsius). At this time, the dye bath is discarded and the fabric can be scoured to remove any unwanted chemicals contained in the fabric, such as any residual acid components.

After all dyeing has been completed, the fabric can be finished in a conventional manner. Examples of conventional finishing processes can include the application of FR treatments, wicking agents, water repellents, stiffening agents, permanent press resins, softeners, and the like.

The fabrics, yams, and fibers to be dyed in accordance with embodiments of the invention need not contain only aramid fibers. Rather, such fibers may be blended with other fibers capable of withstanding the processing temperatures disclosed above, including, but not limited to polyester, cellulosics such as cotton and lyocell, and nylon.

Table 1 indicates the dyeing effectiveness that certain dyes and acids have on certain aramid fabrics. These fabrics were first treated with only the acid component, and the resulting color of such fabrics was noted. The fabrics were then dyed using the exhaust dyeing process described above for approximately 60 minutes at approximately 392 degrees Fahrenheit (200 degrees Celsius). More specifically, the fabrics were introduced into a dye bath having both an acid component and a dye, and a visual assessment of color yield was made. In this way, it could be determined whether a particular dye (when combined with a particular acid component) was effective at dyeing a particular fabric to the desired color as dictated by the dye (e.g., blue, red, yellow, orange, green, etc.). The notation “GOOD” indicates a suitable color yield was obtained (i.e., the dye was effective at dyeing the fabric). The notation “POOR” indicates a marginal color yield. The notation “NO” indicates an unsuitable or no observable color yield.

TABLE 1

| | | FABRIC | FABRIC | FABRIC |
|---|---|---|---|---|
| | | #1: | #2: 88 | #3: |
| CI DYE | | T462 | Conex/10 | Caldura |
| NUMBER | DYE ACID | Nomex | Twaron | S/239 |
| Disp. Blue 56 | NONE | GOOD | GOOD | GOOD |
| Basic Blue 3 | 8.0 g/L Acetic | GOOD | GOOD | GOOD |
| | Acid or 3.0 | | | |
| | g/L Urea | | | |
| | Sulfateor 3.5 | | | |
| | g/L Formic | | | |
| | Acid or 2.5 | | | |
| | g/L Citric Acid | | | |
| Basic Blue 77 | 1.0 g/L Citric | NO | NO | NO |
| | Acid | | | |
| Basic Blue 41 | 2.0 g/L Urea | NO | NO | NO |
| | Sulfate | | | |
| Basic Blue 147 | 1.0 g/L Citric | GOOD | GOOD | GOOD |
| | Acid | | | |
| Basic Red 29 | 1.0 g/L Citric | GOOD | POOR | POOR |
| | Acid | | | |
| Basic Red 46 | 1.0 g/L Citric | NO | NO | NO |
| | Acid | | | |
| Basic Red 14 | 1.0 g/L Citric | GOOD | POOR | GOOD |
| | Acid | | | |
| Basic Yellow 28 | 1.0 g/L Citric | GOOD | POOR | POOR |
| | Acid | | | |
| Basic Yellow 29 | 1.0 g/L Citric | GOOD | GOOD | POOR |
| | Acid | | | |
| Basic Orange 22 | 1.0 g/L Citric | GOOD | POOR | GOOD |
| | Acid | | | |
| Basic Yellow 45 | 1.0 g/L Citric | GOOD | POOR | POOR |
| | Acid | | | |
| Basic Yellow 21 | 1.0 g/L Citric | POOR | POOR | POOR |
| | Acid | | | |
| Basic Blue 75 | 1.0 g/L Citric | GOOD | GOOD | GOOD |
| | Acid | | | |
| Basic Green 4 | 1.0 g/L Citric | GOOD | NO | NO |
| | Acid | | | |
| Basic Blue 60 | 1.0 g/L Citric | GOOD | POOR | NO |
| | Acid | | | |
| Basic Blue 141 | 1.0 g/L Citric | GOOD | GOOD | GOOD |
| | Acid | | | |
| Basic Red 15 | 1.0 g/L Citric | POOR | GOOD | NO |
| | Acid | | | |
| Basic Yellow 51 | 1.0 g/L Citric | GOOD | GOOD | GOOD |
| | Acid | | | |
| Disp. Blue 79:1 | 1.00 g/L Citric | GOOD | GOOD | GOOD |
| (2.5% owf) | Acid | | | |
| Basic Red 18 | 1.00 g/L Citric | GOOD | GOOD | GOOD |
| (1.5% owf) | Acid | | | |
| Basic Yellow 13 | 1.0 g/L Citric | GOOD | GOOD | GOOD |
| | Acid | | | |
| Basic Yellow 40 | 1.0 g/L Citric | GOOD | GOOD | GOOD |
| | Acid | | | |
| Basic Blue 45 | 1.00 g/L Citric | GOOD | GOOD | GOOD |
| (1.5% owf) | Acid | | | |
| Basic Red 23 | 1.00 g/L Citric | GOOD | GOOD | GOOD |
| (1.5% owf) | Acid | | | |
| Basic Red 22 | 1.00 g/L Citric | GOOD | GOOD | GOOD |
| (1.5% owf) | Acid | | | |
| Disp. Red 167 | 1.0 g/L Citric | GOOD | GOOD | GOOD |
| | Acid | | | |
| Disp. Yellow | 1.0 g/L Citric | GOOD | GOOD | GOOD |
| 198 | Acid | | | |
| Ter Flavine | 1.0 g/L Citric | GOOD | NO | NO |
| 8GFF | Acid | | | |
| Disp. Red 179 | 1.0 g/L Citric | GOOD | GOOD | GOOD |
| | Acid | | | |
| Acid Blue 204 | 1.00 g/L Citric | Not | POOR | Not |
| | Acid | tested | | tested |
| Acid Orange | 1.00 g/L Citric | Not | GOOD | Not |
| 156 | Acid | tested | | tested |
| Acid Blue 193 | 1.00 g/L Citric | Not | POOR | Not |
| | Acid | tested | | tested |
| Acid dye | 1.00 g/L Citric | Not | GOOD | Not |
| marketed | Acid | tested | | tested |
| asTelon Blue | | | | |
| A3GL available | | | | |
| from DYSTAR | | | | |
| LP | | | | |

The above examples are provided by way of example only, and are not intended to limit the scope of the invention. Rather, various combinations of dyes, dye acids, and fibers and/or fabrics can be dyed with different parameters (e.g., temperatures, time, etc.), all of which may affect the dyeability and/or colorfastness of the particular fabric being dyed.

The dyeing methods disclosed herein enable aramid fibers and fabrics made from such fibers to be dyed to have acceptable levels of laundering colorfastness without the use of accelerants or carriers. Fabrics dyed in accordance with this invention will not contain residual amounts of such accelerants or carriers and thus will not suffer from the same performance problems (i.e., flammability, unsatisfactory color fastness, odor) as fabrics containing such solvents.

Moreover, the dyeing methods disclosed herein may be used to dye filament aramid fibers in addition to staple aramid fibers, which has heretofore been difficult given the extreme crystallinity of the filament fibers. Nevertheless, the above-disclosed methods were found to sufficiently reduce the crystallinity of the filament fibers, thereby rendering them capable of accepting dyes.

Fabrics having fibers dyed in accordance with the methods disclosed herein can be used to construct the entirety of, or various portions of, a variety of protective garments, including, but not limited to, coveralls, jumpsuits, shirts, jackets, vests, and trousers, for protecting the wearer against thermal hazards such as electrical arcs and flames. Retroreflective elements, such as strips of retroreflective tape, may be provided on portions of the exterior of the garments to enhance the visibility of the garment wearer. In one embodiment, fabrics dyed in accordance with embodiments of the invention can have specific physical characteristics that satisfy heat, flame, and fire performance and safety standards, for example, National Fire Protection Association (NFPA) 1971, 1991 Edition (and in particular NFPA 2112 and NFPA 70E), ASTM F 1506, MIL C 43829C, and EN 469.

The invention claimed is:

1. A process for dying inherently flame resistant fibers comprising:
immersing a plurality of fibers in an aqueous bath comprising at least one dye and at least one acid component, wherein the bath does not comprise a carrier and wherein the plurality of fibers comprises inherently flame resistant fibers;
increasing the temperature of the bath to between about 285° F. and about 400° F.; and
maintaining the temperature of the bath for between about 20 minutes and about 120 minutes.

2. The process of claim 1, further comprising cooling the bath to equal to or less than about 113° F.

3. The process of claim 2, further comprising scouring the plurality of fibers after cooling.

4. The process of claim 1, further comprising finishing the plurality of fibers.

5. The process of claim 4, wherein finishing the plurality of fibers comprises applying to the fibers at least one of a flame resistant agent, a wicking agent, a water repellant agent, a stiffening agent, a permanent press resin, or a softener.

6. The process of claim 1, wherein the plurality of fibers comprises aramid fibers, polybenzimidazole fibers, melamine fibers, polyamide fibers, polyimide fibers, or polyimideamide fibers.

7. The process of claim 6, wherein the plurality of fibers comprises aramid fibers.

8. The process of claim 7, wherein the aramid fibers comprise para-aramid fibers, meta-aramid fibers, or a blend thereof.

9. The process of claim 6, wherein the plurality of fibers comprises polybenzimidazole fibers.

10. The process of claim 1, wherein immersing the plurality of fibers in the aqueous bath comprises immersing at least one yarn comprising at least some of the plurality of fibers in the aqueous bath.

11. The process of claim 1, wherein immersing the plurality of fibers in the aqueous bath comprises immersing a fabric comprising at least some of the plurality of fibers in the aqueous bath.

12. The process of claim 1, wherein the plurality of fibers further comprises polyester fibers or cellulosic fibers.

13. The process of claim 1, wherein the plurality of fibers further comprises cotton fibers or lyocell fibers.

14. The process of claim 1, wherein the dye comprises at least one of an acid dye, a basic dye, or a disperse dye.

15. The process of claim 1, wherein the acid component comprises a non-volatile acid, a volatile organic acid, or an acid salt.

16. The process of claim 1, wherein the acid component comprises at least one of citric acid, oxalic acid, adipic acid, urea sulfate, formic acid or acetic acid.

17. The process of claim 16, wherein the acid component comprises citric acid or urea sulfate.

18. The process of claim 1, wherein increasing the temperature of the bath comprises increasing the temperature of the bath to about 392° F., and wherein maintaining the temperature of the bath comprises maintaining the temperature of the bath for about 60 minutes.

19. A protective garment comprising fibers dyed by the process of claim 1.
